(19) United States
(12) Patent Application Publication
(10) Pub. No.: US 2005/0229718 A1
(43) Pub. Date: Oct. 20, 2005

(54) Impeller for data acquisition in a flow

(76) Inventors: Fabien Cens, Massy (FR); Gilbert Galland, Clamart (FR); Jean-Pierre Chyzak, Eury Gregy sur Yerres (FR)

Correspondence Address: SCHLUMBERGER OILFIELD SERVICES, 200 GILLINGHAM LANE, MD 200-9, SUGAR LAND, TX, 77478, US

(21) Appl. No.: 10/521,976

(22) PCT Filed: Jun. 25, 2003
(86) PCT No.: PCT/EP03/50261

§ 371 Date: May 16, 2005

(30) Foreign Application Priority Data
Jul. 23, 2002 (FR) 0209332

(51) Int. Cl. G01F 1/05

(52) U.S. Cl. 73/861.79

(57) ABSTRACT

This invention relates to an impeller for data acquisition in a flow. It comprises blades (1) and a hub (2). It is made of a plastic material and it is insert moulded by trapping a spindle (3) and at least one magnet (4) in its hub (2). Application particularly for data acquisition in hydrocarbon wells.

### TECHNICAL DOMAIN

This invention relates to an impeller for use on a data acquisition instrument in a flow and an instrument for data acquisition equipped with such an impeller.

### STATE OF PRIOR ART

It is required to acquire a number of data about the multiphase fluid that flows in a well as precisely as possible, in order to perform maintenance functions, particularly in hydrocarbon production wells. For example, these data may include the nature, the flow and the proportion of the different phases in the fluid. In a hydrocarbon production well, there is usually a three-phase fluid formed of oil, gas and water. These fluid phases do not have the same density, they do not move at the same velocity, they are not present in the same proportions and they do not enter the well at the same location. The distribution of the different fluid phases in the flow is different depending on whether the well is vertical, inclined or horizontal. Due to the difference in density in the different fluid phases, these phases become gradually stratified as the inclination of the well increases. In a particular section of an inclined well, or possibly even a horizontal well, several phases may be present moving at different velocities and in different directions. The different phases in an approximately vertical well mix uniformly.

The required data can be acquired by placing an instrument, for example conform with the instrument described in patent application FR-A1-2 797 295, in the well.

This instrument comprises means of determining the local fluid velocity, in several parts of the well. One of the means is installed in the body of the instrument and other means are installed on a mechanism that can be extended in the form of an arm. When the instrument is inserted in a horizontal or deviated well, the body rests on the lowest part of the well and the deployed mechanism occupies the entire width of the well. Means of determining the velocity are distributed across the entire width of the well.

Means of determining the local fluid velocity comprise a small impeller for which the axis of rotation is approximately parallel to the longitudinal axis of the well. The impellers cooperate with contact free sensors that acquire information about their rotation velocity and possibly their rotation direction.

In a well with a small inclination or even a horizontal well, the velocities to be measured may be very low, for example of the order of a few centimetres per second, or they may be much higher, for example several meters per second. Very viscous crude oil may move at these low velocities, whereas water and gas may move at these high velocities.

If the measurements are to be reliable, it is particularly important that the impeller should be sensitive to this entire range of velocities. By comparison, in a vertical well, the velocity of the relatively homogenous mix is of the order of a few tens of centimetres to a few meters per second. The multiphase fluid is at a temperature of about 150° C., its pressure is about 10⁸ Pa and it may be very corrosive. It may contain compounds containing sulphur, sand or other debris in suspension. The impeller must be capable of resisting these difficult conditions.

At the moment, impellers are made of metal or a plastic material by machining and the cost is relatively high. These impellers are fixed to at least one magnet. Rotation of the impeller generates a periodic variation of the magnetic field that can be detected by one or more magnetic sensors. This variation in the magnetic field is representative of the velocity and direction of rotation of the impeller.

It is known that the magnet can be placed close to the impeller, but it then has to be protected from the multiphase fluid which is highly corrosive. The assembly consisting of the impeller and the magnet then become complicated and expensive because a protective chamber has to be provided for the magnet. The assembly also becomes voluminous and the flow is modified as a result.

Another possibility that was considered is to house the magnet inside the hub of the impeller, but the housing is to be formed while the impeller is being machined, and once the magnet is in position, the housing has to be closed off so that the magnet is fully protected. This structure also has a high cost.

### PRESENTATION OF THE INVENTION

The purpose of this invention is to propose an impeller for data acquisition in a flow that does not have the disadvantages mentioned above.

One purpose of the invention is to propose an impeller that is particularly easy to make and is inexpensive while being very high performance.

Another purpose of the invention is to propose an impeller that is light weight, that has a low inertia force to start rotation even with very flow fluid velocities.

Another purpose of the invention is to propose an impeller that resists the corrosive fluid in which it is immersed, even if it contains sand or debris.

This invention achieves these purposes by the use of an impeller for data acquisition in a flow comprising blades and a hub, characterized in that it is made of a plastic material and that it is insert moulded, trapping a spindle and at least one magnet at its hub.

The impeller also contains an insert in which the magnet is housed.

It is preferable that the insert and the spindle are fixed to each other.

The insert may be crimped around the spindle.

The spindle may have a reduced cross section. at the crimping.

The impeller preferably comprises at least one pair of magnets located on each side of the spindle and attracting each other.

The plastic material is advantageously a polyethercetone type of thermoplastic resin.

Preferably, the magnet is made based on samarium cobalt, the spindle is based on tungsten carbide and the insert is based on aluminium.

This invention also relates to a data acquisition instrument in a flow that comprises at least one impeller, characterized as described above.

### BRIEF DESCRIPTION OF THE DRAWINGS

This invention will be better understood after reading the description of example embodiments given for information purposes only and in no way limitative, with reference to the attached drawings in which:

FIGS. 1A and 1B show a longitudinal and cross sectional view of an impeller conform with the invention;

FIG. 2 shows an instrument for data acquisition in a hydrocarbon well comprising an impeller conform with the invention.

Identical, similar or equivalent parts in the different figures described below have the same numeric references to facilitate the passage from one figure to the next.

The various parts shown in the figures are not necessarily shown at the same scale, to make the figures more legible.

### DETAILED DESCRIPTION OF PARTICULAR EMBODIMENTS

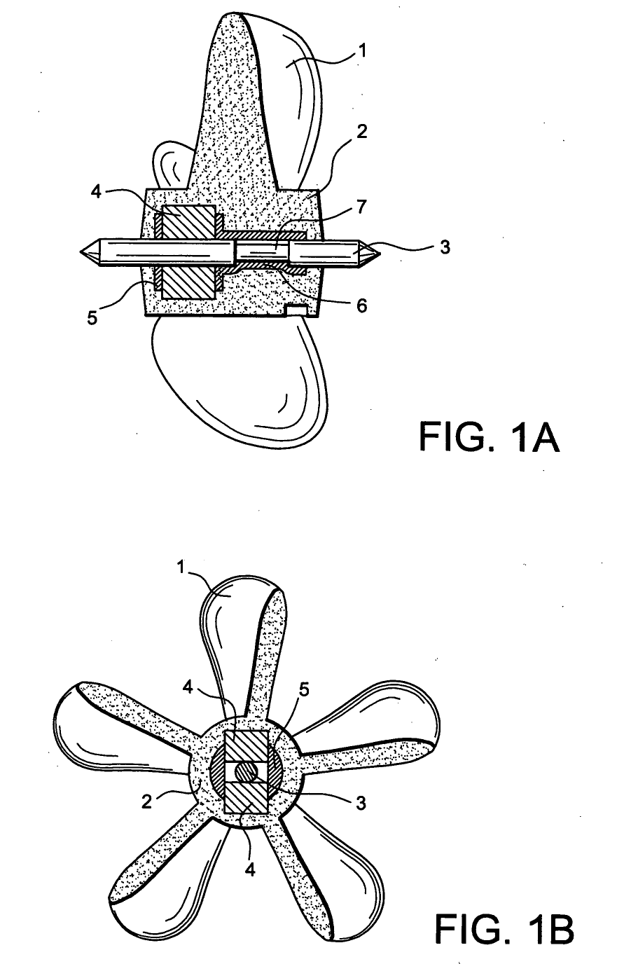

The impeller shown in FIGS. 1A, 1B have blades 1, for example five blades, and a hub 2. This number of five blades is not limitative, it would be possible for the impeller to have more blades 1 or less blades 1. However, an odd number is preferable to give a more uniform rotation, with the impeller support never concealing more than one blade at a time.

According to one characteristic of the invention, the impeller made of a plastic material is insert moulded, trapping a spindle 3 and at least one magnet 4 in its hub 2. The magnet 4 is housed in an insert 5 that is also trapped in the hub 2 of the impeller.

In this context, the term insert moulding means that the moulded material contains at least one “trapped body” inside it.

By insert moulding the impeller around the spindle 3, at least one magnet 4 and the insert 5, a particularly compact assembly is obtained that is both inexpensive and has a high performance. The manufacturing cost can be reduced by a factor of about 10 compared with traditional impellers that were machined. It must be remembered that these impellers are relatively small and their diameter is only few centimetres, for a application in approximately horizontal hydrocarbon wells. Furthermore, it is very easy to make blades 1 with various shapes by moulding, that would be difficult or impossible to make by machining.

It is preferable to provide means 6 of solidarising the insert 5 and the spindle 3. This can be done by crimping the insert 5 around the spindle 3. The crimping is marked as reference 6. The spindle 3 then comprises a part 7 with a reduced cross section at the crimping 6.

Preferably, at least one pair of magnets 4 will be used. The two magnets 4 in the pair will be placed on each side of the spindle 3 so that they attract each other. The North pole of one will be close to the spindle 3 and the South pole of the other will be close to spindle 3.

By positioning the two magnets 4 on opposite side of the spindle 3, this achieves a given dynamic equilibrium when the impeller is rotating, due to the fact that the weight of a magnet is not negligible compared with the weight of the impeller itself. The two magnets 4 induce two detection pulses for each rotation of the impeller, which makes the velocity measurement more accurate.

The spindle 3 will advantageously be made based on tungsten carbide which is sufficiently robust to resist the corrosive fluid in the flow.

The insert 5 will be made of metal, for example based on aluminium which is sufficiently ductile to be crimped and is non magnetic.

The magnets 4 may advantageously be made of samarium cobalt. One of the highest values of the magnet size/magnetic energy ratio can be obtained using this material.

Furthermore, samarium cobalt magnets have a good resistance to high temperatures, firstly the injection temperature of the thermoplastic material of the impeller which is about 400° C., and secondly the usage temperature in the well which is about 150° C.

Since they are trapped in the hub 2 of the impeller, they are protected from the corrosive fluid of the flow.

The material from which the impeller is made will preferably be a thermoplastic material that can be injection moulded and will be chosen for its light weight and high resistance. For example a thermoplastic resin such as polyethercetone is very suitable. This resin is known under the name VICTREX PEEK 450 GL 30 which is a registered mark of I.C.I. (IMPERIAL CHEMICAL INDUSTRIES).

This type of impeller may easily be installed on its spindle 3, on a stirrup shaped support of an impeller device like that described in the French patent application in the name of the applicant deposited on the same day as this application.

The magnet 4 is intended to excite a magnetic movement sensor (not shown) that will acquire information about the velocity of the impeller and that is placed close to it. This sensor is fixed to the support. The impeller device with its support is shown in FIG. 3, marked with reference 31, while the support and the impeller are marked with references 10 and 11 respectively.

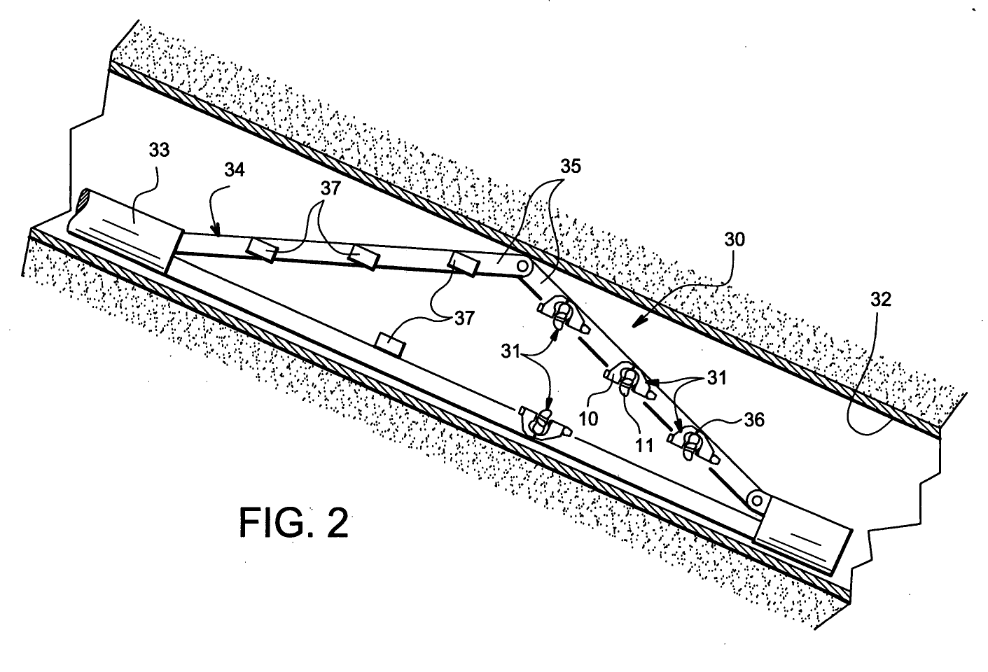

FIG. 2 diagrammatically shows an example of a data acquisition instrument 30 of the type described in patent application FR-A 2 797 295. It comprises several impellers 11 described as above, each installed on an impeller device 31. The instrument 30 is lowered into an inclined or approximately horizontal hydrocarbon well 32. The instrument 30 is connected to the surface by a rod or a cable not shown. The data acquired in the instrument 30 are transmitted to the surface by the cable, the rod or by telemetry. The instrument 30 comprises an approximately cylindrical body 33 with a diameter smaller than the diameter of the well 32. The body 33 is fixed to an extendable mechanism 34. The extendable mechanism 34 comprises two arms 35 articulated to each other and with the body 33. The body 33 is supported on the lower wall of the well 32. During extension, the arms 35 are in the shape of a V located in a vertical plane containing the longitudinal centre line of the well 32. The impeller devices 31 are distributed fairly uniformly along one of the arms 35. They are fixed to the arm by a split pin 36, for example, that passes through a support orifice 10. The other arm may be equipped with electronic sensors 37 and/or optical sensors also distributed fairly uniformly along the arm. An impeller device 31 and/or at least one sensor 37 may be placed on the body 33.

Although only one embodiment of this invention has been represented and described in detail, it can be understood that different changes and modifications may be made without going outside the scope of the invention, particularly to the shape of the impeller.

Data acquisition in a hydrocarbon well has been used as an example application, but obviously this impeller could be used in other domains, for example in a submarine environment or even in a borehole other than an oil well.

1-11. (canceled)

12. Impeller for data acquisition in a flow, comprising blades (1) and a hub (2), wherein the impeller is made of a plastic material and is molded by trapping a spindle (3) and at least one magnet (4) in its hub (2).

13. Impeller according to claim 12, wherein the impeller also traps an insert (5) to house the magnet (4).

14. Impeller according to claim 13, wherein the insert (5) and the spindle (3) are fixed to each other.

15. Impeller according to claim 14, wherein the insert (5) is crimped around the spindle (3).

16. Impeller according to claim 15, wherein the cross section (7) of the spindle (3) is reduced at the crimping (6).

17. Impeller according to claim 12, wherein the impeller comprises at least one pair of magnets (4) on each side of the spindle (3) that attract each other.

18. Impeller according to claim 12, wherein the plastic material is a polyethercetone type thermoplastic resin.

19. Impeller according to claim 12, wherein the magnet (4) is based on samarium cobalt.

20. Impeller according to claim 12, wherein the spindle (3) is based on tungsten carbide.

21. Impeller according to claim 13, wherein the insert (5) is based on aluminum.

22. Data acquisition instrument in a flow, comprising at least one impeller (11) according to claim 12.
